(19) United States
(12) Patent Application Publication
(10) Pub. No.: US 2017/0240407 A1
(43) Pub. Date: Aug. 24, 2017

(54) DEVICE FOR DISPENSING A GAS-CONTAINING LIQUID, WITH A VALVE FOR INTRODUCING CO2

(71) Applicant: AF ADMINISTRAÇÃO, PARTICIPAÇÃO E EMPREENDIMENTOS LTDA-ME, Sao Paulo (BR)

(72) Inventor: Alvaro Augusto Fernandes Filho, Sao Paulo (BR)

(73) Assignee: AF ADMINISTRAÇÃO, PARTICIPAÇÃO E EMPREENDIMENTOS LTDA-ME, Sao Paulo (BR)

(21) Appl. No.: 15/519,371

(22) PCT Filed: May 29, 2015
(86) PCT No.: PCT/IB2015/054093

§ 371 Date: Apr. 14, 2017

(30) Foreign Application Priority Data
Oct. 15, 2014 (BR) BR1020140257470

(51) Int. Cl. B67D 1/04; B67D 1/00; B67D 1/02; B01F 3/04

(52) U.S. Cl. CPC B67D 1/0418; B01F 3/04801; B67D 1/0004; B67D 1/025; B01F 2003/049; B01F 2215/0022; B01F 2215/007; B67D 2001/0092; B67D 2001/0094

(57) ABSTRACT

DEVICE FOR DISPENSING A GAS-CONTAINING LIQUID, WITH A VALVE FOR INTRODUCING CO2, which has been developed to provide a better use, way of serving and flow control for carbonated beverages, particularly, a flow control device to reduce the gas dissipation on the beverage, whether it is from the quantity remaining in the bottle or the drink to be served.

This patent of invention application refers to a DEVICE FOR DISPENSING A GAS-CONTAINING LIQUID, WITH A VALVE FOR INTRODUCING CO2, which was developed to provide a flow control to carbonated beverages, particularly a flow controller to reduce gas dissipation in such drinks, whether from the quantity inside the container or when it is served.

### STATE OF THE ART

In gasified beverage industries, including soft drinks, water, beers, dairy products, juices, wines, are segments that aim at providing a better gas conservation within the containers, and preserving their gas for a longer period to provide gasified beverages a better use.

A bottled carbonated beverage has a significant quantity of carbon dioxide diluted in water, which are two of all carbonated soft drinks basic ingredients. A great carbon dioxide quantity is diluted in the beverage to ensure minimum effervescence after opening such drink and placing it in a cup. Dispense a carbonated beverage in a container results in a significant carbon dioxide loss, which generally is seen as foam formation.

The foam formation and carbonation loss are regarded to the quantity and quality, as they are not directly related to the same problem.

The foam formation refers to, among other features, with the rate a drink may be served in a cup or other container.

If a great foam quantity is produced, the beverage volume provided is fairly low and increases time to fill a cup due to the time it takes to dissipate such foam.

The carbonation loss occurs both in the drink to be served and the one that remains inside the bottle. In both cases, the beverage loses its effervescent properties and the taste becomes less attractive for most people.

Actually the reduced effervescence decreases beverage aroma, which is interpreted as a taste loss.

Regardless of what happens, the beverage industry bases itself upon customers understanding and perception, which is that such beverage loses its taste.

With “PET” (polyethylene terephthalate) bottles popularity, it is extremely important that the beverage in a partially empty bottle maintains its original aroma and taste.

Bottling industry solves the dissolution problem of a big carbon dioxide quantity in the beverage.

Opening a bottle and pour a drink, through the bottleneck, reduces its effervescence in two ways.

Opening or removing a bottle seal results in CO2 dispersion, escaping from the beverage during transportation and storage.

Pour, by tipping the container over, disrupts the beverage and releases diluted carbon dioxide in the drink served and in the remaining quantity in the bottle.

After diluting a big carbon dioxide quantity in the beverage, bottler try to ensure some of the gas remains diluted until the last beverage quantity is served.

Bearing the abovementioned situation in mind, it hereby presents an invention objective and a method to provide a better gas conservation inside bottles with minimum modification or variance in the beverage bottling process, having a better use of gasified beverages, as they keep gas for much longer, after tipping the liquid over from the container, as customers may feel like saving, then avoiding unnecessary gas dispersion and micro-organism that disrupt the liquid from entering, contributing for the environment, as it is more efficient in an ecological manner.

Other invention objective is to preserve container gases when it is attached, fixing the serving device.

Another one is a flow control for for carbonated beverages, that is able to drain a great liquid quantity with minimum foam quantity.

Other invention objective is to provide a flow control for carbonated beverages, resulting in minimum gas loss on served drinks.

Another one is a flow control for carbonated beverages that quickly provides a determined beverage volume with minimum foam quantity.

Other invention objective is to provide a flow control for carbonated beverages, which may be added to existing containers.

Another one is to provide a pouring system that pours the carbonated beverage through the bottle accumulated pressure after attaching it to the container.

Another invention objective is to provide a CO2 introduction system inside a bottle, in order to keep a pressurized and carbonated beverage.

Another one is to offer less carbonated liquid waste, making customers save more.

Another objective is to reduce unnecessary carbon dioxide dispersion, then helping the environment.

Other invention objective is to pressurize liquid in containers.

In order to have a perfect understanding of such development, drawings have been attached, to which make numerical reference with a detailed description, where:

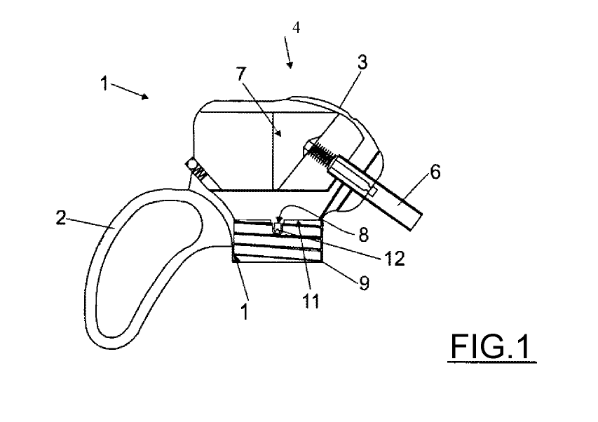

FIG. 1 is a cutaway drawing of the injecting body.

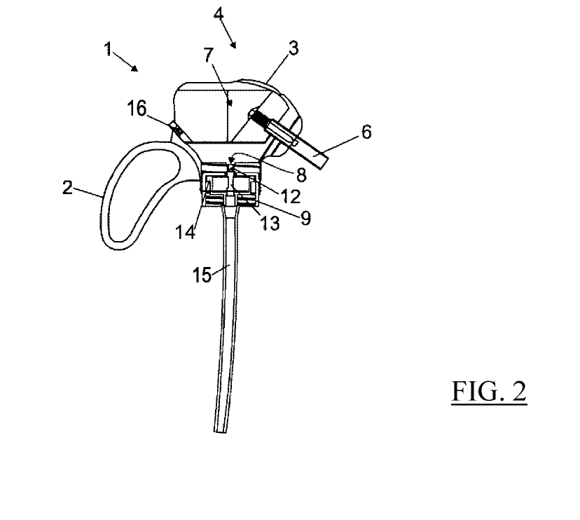

FIG. 2 is a cutaway drawing of the set.

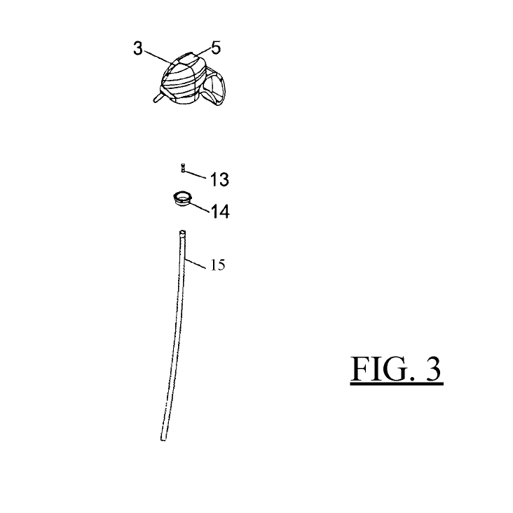

FIG. 3 is a exploded view of the set.

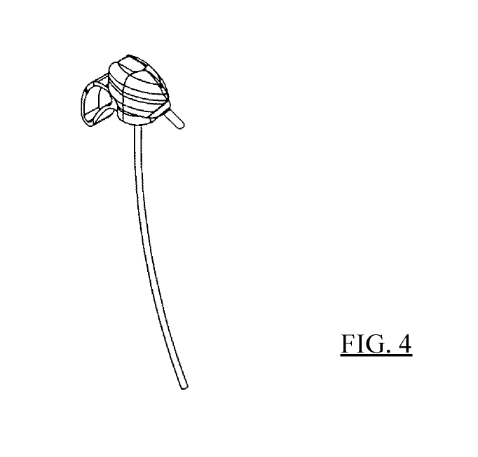

FIG. 4 is a perspective view of the set.

Thus the request hereby has been developed to provide a DEVICE FOR DISPENSING A GAS-CONTAINING LIQUID, WITH A VALVE FOR INTRODUCING CO2, comprised of a main body (1) with a gripping handle (2), which extends itself, forming an injecting body (3) placed on the upper section (4), of a trigger (5) that activates an injection valve (6) connected to a pod (7), which is linked to a liquid insert hole (8) placed in a female coupling (9) with a thread (10) whose bottom (11), has a breaking shaft (12) that drags the retention valve (13) vertically, located inside the cup (14) projecting an aspiration tube (15) in a lower position, within the bottle, as the main body (1) is equipped with a recipient valve (16), in order to attach a CO2 cylinder that fills such bottle.

Based on the description and illustration we may check the DEVICE FOR DISPENSING A GAS-CONTAINING LIQUID, WITH A VALVE FOR INTRODUCING CO2 brings some advantages regarding the ones currently on the market, as it offers a flow control for carbonated beverages, providing a great beverage flow with minimum foam formation quantity and a maximum effervescence quantity in the drink served and that remains on the bottle.

The flow control shall be attached to the container closure, which has an external thread to attach it, as the only modification in the bottling process is placing the external thread closure (9), retention valve (13), cup (14) and aspiration tube (15).

In glass containers that do not have a thread, the external thread device (17) shall be attached first, which allows the flow control attachment.

The flow control may also be added to the current containers and make part of new ones.

The flow control seals the bottle to avoid gas loss and retain the maximum gas quantity in the remaining beverage inside the bottle.

For example, the flow control may include a manual pump or a CO2 cartridge for propulsion from liquid bottles.

As it is new and by then not understood in the technique status, it fits perfectly to the criteria provided in the patent of invention. Its claims are as follows.

1. DEVICE FOR DISPENSING A GAS-CONTAINING LIQUID, WITH A VALVE FOR INTRODUCING CO2, characterized by a main body (1) with a gripping handle (2), which extends itself, forming an injecting body (3) placed on the upper section (4), of a trigger (5) that activates an injection valve (6) connected to a pod (7), which is linked to a liquid insert hole (8) placed in a female coupling (9) with a thread (10) whose bottom (11), has a breaking shaft (12) that drags the retention valve (13) vertically, located inside the cup (14) projecting an aspiration tube (15) in a lower position, within the bottle, as the main body (1) is equipped with a recipient valve (16), in order to attach a CO2 cylinder that fills such bottle.

2. DEVICE FOR DISPENSING A GAS-CONTAINING LIQUID, WITH A VALVE FOR INTRODUCING CO2, characterized by a gasified beverage distributing unit, comprised of such distributing unit: a closure to seal the bottle, as such closure has an inner and outer thread, a valve to be moved through the main body of the beverage draining flow control when attached to said bottle without wasting gas, a tube that has a first end connected to such closure and a second end on the bottle to move the beverage to such closure.

3. DEVICE FOR DISPENSING A GAS-CONTAINING LIQUID, WITH A VALVE FOR INTRODUCING CO2, characterized by the flow control including a manual pump or a CO2 cartridge for propulsion from beverage bottles.
